(19) United States
(12) Patent Application Publication
(10) Pub. No.: US 2015/0182879 A1
(43) Pub. Date: Jul. 2, 2015

(54) Device and method for thickening liquid substrate containing solid material

(71) Applicant: Boerger GmbH, Borken-Weseke (DE)

(72) Inventor: Alois Boerger, Borken-Weseke (DE)

(21) Appl. No.: 14/547,686

(22) Filed: Nov. 19, 2014

(30) Foreign Application Priority Data
Nov. 21, 2013 (DE) 102013112878.5

(51) Int. Cl. B01D 17/00

(52) U.S. Cl. CPC B01D 17/08

(57) ABSTRACT

A device for thickening liquid substrate containing solid material, having a liquid permeable filter pipe that retains solid material, and a rotatable screw conveyor in the filter pipe. A substrate inlet leads into and a liquid outlet and a solid material outlet go out from the filter pipe. Solid material from the introduced substrate is deposited on an inner surface of the filter pipe, and, using the screw conveyor, solid material for the forming a solid material plug is pressed into a pressure duct situated between the filter pipe and the solid material outlet, and is discharged from the pressure duct through the solid material outlet. The screw conveyor has an outer diameter that is smaller than the inner diameter of the filter pipe by an amount that permits the formation of a carpet-type solid material coating, forming a fine filter, on the inner circumference of the filter pipe.

### CROSS-REFERENCES TO RELATED APPLICATIONS

This application claims the benefit of the German patent application No. 102013112878.5 filed on Nov. 21, 2013, the entire disclosures of which are incorporated herein by way of reference.

### BACKGROUND OF THE INVENTION

The present invention relates to a device for thickening liquid substrate containing solid material, having at least one filter pipe that is permeable to liquid and that retains solid material, and having a screw conveyor capable of rotation in the filter pipe, having a substrate inlet leading into the filter pipe, having a liquid outlet going out from the filter pipe, and having a solid material outlet, solid material being capable of being deposited on an inner surface of the filter pipe from the introduced substrate, and, using the screw conveyor, solid material for the formation of a solid material plug being capable of being pressed into a pressure duct situated between the filter pipe and the solid material outlet, and being capable of being discharged from the pressure duct through the solid material outlet.

Moreover, the present invention relates to a method for thickening liquid substrate containing solid material, in particular for operating a device of the type named above.

A device of the type named above, in the form of a liquid separator, is known from DE 10 2010 031 072 A1. Here, the substrate that is to be thickened, and separated into its liquid and solid fractions, is supplied to the liquid separator from a supply reservoir using a pump. Inside the liquid separator, which is essentially made up of a filter pipe having slit-type openings, a liquid separation takes place. The required difference in pressure is provided here by the pump that conveys the substrate into the liquid separator, and by a spatial element in the filter pipe that is capable of being rotationally driven. In addition, the liquid separator is equipped with a pressure duct into which the solid materials conveyed by the spatial element can be conveyed, in order there to be pressed together to form an annular plug or press cake. A mouthpiece, or ejection region, of the pressure duct is sealed by a flap that rotates together with the spatial element. In order to keep the flap normally in the closed state, a spring applies pressure to it. Due to a constant buildup of the plug that takes place during operation of the liquid separator, this plug presses against the flap from the inside, and displaces it outward against the force of the spring. In this way, an annular gap forms between the flap and the pressure duct. The solid material plug can be conveyed out through this annular gap.

In this known liquid separator, it is regarded as disadvantageous that the plug in the pressure duct is subject to the pressure of the substrate produced by the pump. This makes it necessary to produce a very stable plug in order to prevent an undesired breaking through of the substrate under pressure through the solid material outlet. In order to produce such a stable plug, a high drive power must be provided to the spatial element, and the spatial element itself must likewise be made correspondingly stable. This causes increased costs in the production of the separator and in its operation.

### SUMMARY OF THE INVENTION

An object of the present invention is therefore to indicate a device and a method of the type named above by which the named disadvantages are avoided, and with which liquid substrates containing solid material can be effectively thickened, i.e., separated into their solid and liquid fractions, in particular with reduced drive power and with a simpler design, fine to extremely fine solid materials also being separated with the solid fraction and extracted from the liquid fraction.

The solution of the part of the object relating to the device is achieved according to the present invention by a device of the type named above that is characterized in that the screw conveyor has an outer diameter that is smaller than the inner diameter of the filter pipe by a measure that permits the formation of a carpet-type solid material coating, forming a fine filter, on the inner circumference of the filter pipe.

Because the screw has an outer diameter that is smaller than the inner diameter of the filter pipe, the screw conveyor can no longer reach the inner circumferential surface of the filter pipe, and as a result, during operation of the device, as a result of the flow of liquid radially from inside to outside through the filter pipe, a coating of solid material necessarily forms on the inner circumferential surface of the filter pipe, made of the solid material contained in the substrate. During the operation of the device, this coating acts as an intentional filter coating that forms a filter body that in particular retains fine and extremely fine solid material particles from the substrate that would not be retained by the filter pipe alone. Advantageously, in this way, for example during use of the device for the thickening of liquid manure from stalls or digestate from biogas facilities, a significant portion of undesirable nutrients in the incident liquid phase, in particular phosphorus or phosphates, as well as nitrates, collects in the filter coating. The screw conveyor removes excess coating, but always permits a desired coating thickness on the inner circumference of the filter pipe. The removed, saturated solid material of the excess coating is transported by the screw conveyor in the direction toward the solid material outlet in the associated pressure duct. The liquid phase, which then retains only a significantly reduced content of nutrients, can then be used for irrigation purposes, or can be introduced into a drainage channel, without causing unacceptable nutrient loading. The solid material separated in the device, with the nutrients contained therein, provides a dunging material that can be transported and stored, and can be spread onto agricultural areas at times and places where there is a need for dunging.

Preferably, the outer diameter of the screw conveyor is smaller than the inner diameter of the filter pipe by from 0.5 to 5 mm, preferably 1 to 3 mm. In practice, with these dimensions, in most cases an effective filter coating from the solid material forms on the inner circumference of the filter pipe. In the case of small solid material particle sizes, there is a tendency to choose a smaller distance between the screw conveyor outer circumference and the filter pipe inner circumference, while in the case of larger solid material particle sizes, a larger distance is selected between the screw conveyor outer circumference and the filter pipe inner circumference. The correct size of this dimension is usefully determined through trials, because the substrates that are to be thickened and separated into solid and liquid phases in the device according to the present invention are often natural products, such as the mentioned liquid manure or biogas digestate, for which the type and properties, in particular the particle size or spectrum of particle sizes of the solid material, can be different. Therefore, in practice it can turn out that the optimum value for this distance may even be outside the initially indicated range.

A disintegrator or chopper can be connected before the device as needed, in order to provide a suitable and favorable particle size, or particle size distribution, of the solid material in the substrate before it is introduced into the device.

In a further embodiment of the device according to the present invention, it is provided that a vacuum source is connected, or can be connected, to the liquid outlet of the device, by which a difference in pressure, with pressure decreasing from the inside to the outside, can be produced between the interior of the filter pipe and the exterior of the filter pipe. The vacuum source provides the difference in pressure necessary for the filtering process by the filter pipe, ensuring an effective liquid separation at the filter pipe. The solid material plug in the pressure duct ensures that at the solid material outlet there arises an airtight and liquid-tight blockage, while a discharge of solid material nonetheless remains possible.

In addition, the vacuum source in the filter pipe can also usefully produce a vacuum relative to the surrounding environment. Thus, in the device according to the present invention the pressure level inside the device can advantageously be lowered relative to the surrounding environment, so that the solid material plug in the pressure duct is then exposed only to a reduced substrate pressure, or even to no substrate pressure. The plug can therefore be produced with reduced drive power of the screw conveyor, and with a less stable screw conveyor, without the risk of an undesired breaking through of substrate through the solid material outlet. This vacuum can advantageously also be used to convey the substrate into the device without the use of further conveying means.

During operation of the device, the pressure difference produced by the vacuum source supports the buildup of the carpet-type coating made of solid material from the substrate on the inner circumference of the filter pipe. As already mentioned, this carpet-type coating then acts as an intentional fine or extremely fine filter, and fine parts from the substrate, such as for example nutrients that it is desirable to filter out in the case of liquid manure, such as phosphorus, are then deposited in the built-up carpet-type coating. The screw conveyor capable of being driven rotationally constantly removes an excess, radially inner part of the coating, and conveys the saturated solid material in the direction of the pressure duct and solid material outlet.

In order to make it possible to produce the desired vacuum with a low power level of the vacuum source, it is proposed that a throttle be allocated to or connected before the substrate inlet.

In addition, for the device according to the present invention it is provided that the filter pipe is surrounded radially outwardly, at a distance, by a tight jacket, and that a liquid space is formed between the filter pipe and the jacket, and that the jacket has the fluid outlet in its region that is at the lowermost point during operation of the device. In this way, an undesirable and disturbing entry of air into the device is prevented by a simple design.

So that the liquid separated in the device from the substrate can be led away in a targeted manner for waste disposal or further processing, the jacket usefully has, in its region that is the lowermost region during operation of the device, a collecting funnel whose lowest point forms the liquid outlet. A conduit that leads further can then be connected thereto, or a collecting or transport container can be situated here.

In particular for reasons of reliable functioning, preferably the vacuum source is a liquid pump whose suction side is connected, or can be connected, to the liquid outlet. The liquid pump simultaneously provides the desired vacuum and provides for the carrying off of the liquid separated from the substrate. A rotary piston pump is for example well-suited for this purpose.

A system that is favorable for the assembly and disassembly of the device, and for its operation, results in that a liquid carry-off line that carries off the liquid is preferably connected to the liquid outlet, and that the liquid pump, acting as vacuum source, is inserted in the liquid carry-off line.

The above-mentioned throttle is formed by a fixed or adjustable narrowing of the cross-section of the substrate inlet, or by a fixed or adjustable narrowing of the cross-section of a substrate supply line connected before the substrate inlet. A fixed narrowing of the cross-section can for example easily be formed by a rigid screen. An adjustable narrowing of the cross-section can for example be formed by an adjustable valve.

Alternatively, the throttle can be formed by a conveyor device situated in the substrate inlet or in a substrate supply line connected before this inlet, whose power, relative to the power of the vacuum source, can be controlled in such a way that the pressure difference between the interior of the filter pipe and the exterior of the filter pipe results with a desired magnitude.

In addition, for the device according to the present invention it is preferably provided that the screw conveyor has a screw shaft that, at the inlet end of the screw conveyor, leads out from the filter pipe in sealing fashion and is connected to a motor-driven rotational drive having a variable rotational speed. In this way, the screw conveyor can advantageously be driven with a rotational speed that is variable and that can be optimized for the particular case of use. In this way, the rotational drive is moreover easily accessible for maintenance or repair.

In order to increase safety against an undesired passage through or breaking through of liquid substrate through the solid material outlet, it is provided that the solid material outlet can be sealed by a movable closure, and can be released for the discharge of solid material.

The closure at the solid material outlet is preferably formed by a closure plate that is mounted so as to be capable of being moved axially between a closed position and an open position, and is pre-loaded with a force acting in the closing direction. In its closing position, the closure plate automatically closes the solid material outlet. For the discharge of solid material, the closure plate likewise opens automatically, as a result of the force exerted thereon in the opening direction by the solid material, exceeding the closing force.

Usefully, here the closure is capable of being driven rotationally via a mechanical coupling to the screw conveyor, or by a separate rotational drive, in order to produce a relative movement between the solid material and the closure plate that is favorable for the discharge of the solid material.

In order to let the solid material out in as small parts as possible, which as a rule is advantageous for its further use, it is preferably provided that the closure has, on its side facing the solid material outlet, at least one cutting and/or grating tool for detaching and disintegrating solid material discharged from the solid material plug through the solid material outlet.

Alternatively, the closure on the solid material outlet can be formed by a rotary piston pump. This embodiment makes sense in particular if the material brought out through the solid material outlet is still flowable and can be conveyed by the rotary piston pump, for example having a thick liquid or sludge-like or paste-like consistency.

The present invention further proposes that the pressure duct be fashioned in the interior of a pipe segment that forms a continuation of the filter pipe and that is closed at its circumference, or is fashioned in the manner of a sieve at its circumference. With a sieve-type pipe segment, the pressure duct can advantageously also be further used for a liquid separation, if a particularly high degree of separation is desired.

A further embodiment in this regard provides that the pipe segment, given a realization as a sieve pipe, is tightly surrounded by a separate, second jacket, and has a separate, second liquid outlet. Here, as needed the liquid separated in the pressure duct can be carried off and used separately. However, it is also possible for the two outlets to be combined, in order then to carry off all the liquid together.

The solution of the second part of the object, relating to the method, is achieved according to the present invention by a method for thickening liquid substrate containing solid material, in particular for operating a device as recited in one of the preceding claims, the substrate being guided in at least one filter pipe that is permeable to liquid and that retains solid material, having a screw conveyor that is capable of rotation in the filter pipe, solid material from the introduced substrate being deposited on an inner surface of the filter pipe, and, by means of the screw conveyor, solid material being pressed into a pressure duct situated between the filter pipe and a solid material outlet in order to form a solid material plug, and being discharged from the pressure duct through the solid material outlet, which is characterized in that on the inner circumference of the filter pipe there is produced a carpet-type solid material coating that forms a hollow cylindrical fine filter, in that a screw conveyor is used having an outer diameter that is smaller than the inner diameter of the filter pipe by a measure that permits the formation of the carpet-type solid material coating.

Departing from standard procedures, in which it is sought to always keep the inner circumference of the filter pipe as clean and free of solid material as possible, according to the present invention the production of a constant coating of solid material on the inner circumference of the filter pipe is quite deliberately aimed at. In this way, a fine filter, or extremely fine filter, is formed that, in accordance with the method, is connected before the filter pipe, and that makes it possible to filter out the fine and extremely fine solid material particles from the substrate that would not be separated out by the filter pipe alone. In this way, the method according to the present invention achieves the advantages explained above in connection with the device according to the present invention.

Preferably, the carpet-type solid material coating is produced on the inner circumference of the filter pipe with a layer thickness of from 0.5 to 5 mm, preferably 1 to 3 mm, which yields good results in most practical applications. As needed, smaller or larger layer thicknesses of the solid material coating are also possible.

In addition, by means of a vacuum source that is connected or can be connected to the liquid outlet, a pressure difference can be produced between the interior of the filter pipe and the exterior of the filter pipe, with pressure decreasing from the inside to the outside, in order to support the buildup of the solid material coating on the inner circumference of the filter pipe and the separation of the liquid phase from the substrate through the solid material coating and the filter pipe.

In addition, by means of the vacuum source a vacuum relative to the surrounding environment is preferably produced in the filter pipe, which relieves stress on the solid material plug in the pressure duct, and reduces the risk of a breaking through of substrate from the filter pipe through the solid material outlet.

In order to make it possible to produce the vacuum in a targeted and reproducible fashion with a low energy outlay, the substrate flow is usefully throttled in or before the substrate inlet.

In addition, it is preferably provided for the method that the difference in pressure is produced by a liquid pump acting as vacuum source, whose suction side is connected or can be connected to the liquid outlet.

In order to keep the outlay low, preferably the substrate is conveyed through the substrate inlet into the filter pipe by the vacuum produced in the filter pipe by the vacuum source, relative to the surrounding environment.

Alternatively, the method provides that the substrate is supplied to the substrate inlet by a conveyor device connected before this inlet, and that the conveyor device and the vacuum source are calibrated to one another in such a way that, during operation of the device, the difference in pressure between the interior of the filter pipe and the exterior of the filter pipe is produced having a desired magnitude.

### BRIEF DESCRIPTION OF THE DRAWINGS

In the following, an exemplary embodiment of the present invention is explained on the basis of a drawing.

FIG. 1 shows a view of a device for thickening liquid substrate containing solid material, having supply lines and carry-off lines, a pump, and a control unit;

FIG. 2 shows the device of FIG. 1 in a partly cut-away representation;

FIG. 3 shows the region of the device at the left end in FIG. 2, with its solid material outlet, in longitudinal section; and

FIG. 4 shows a segment of the screw conveyor and of the filter pipe surrounding it, in longitudinal section.

In the various Figures, identical parts have always been provided with identical reference characters, so that all reference characters do not have to be explained in reference to all Figures.

### DETAILED DESCRIPTION OF THE PREFERRED EMBODIMENTS

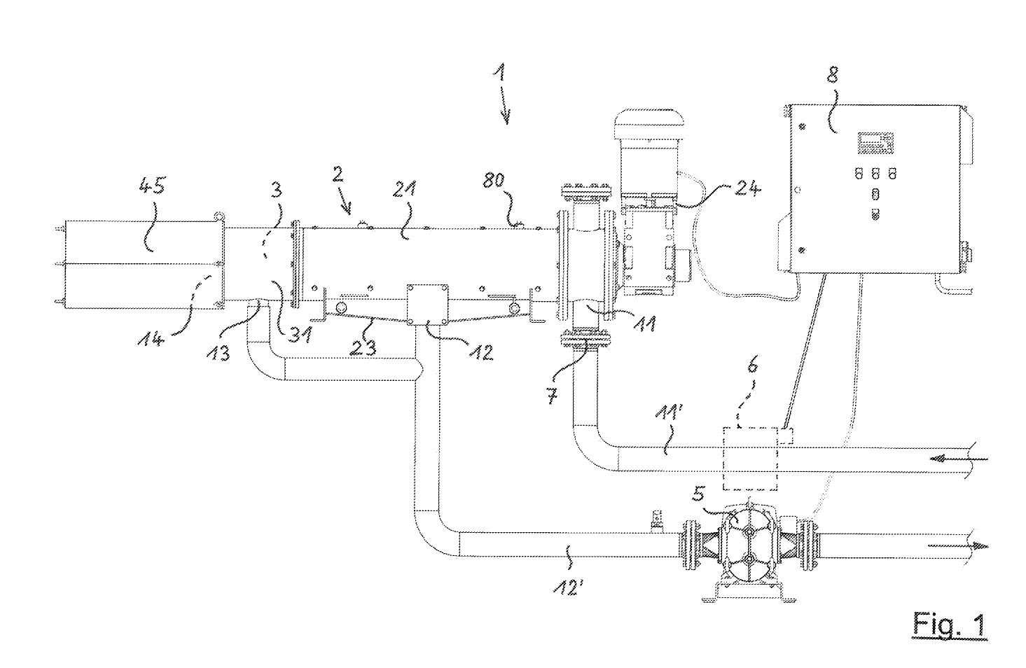

FIG. 1 shows a view of a device 1 for thickening liquid substrate containing solid material, having supply lines and carry-off lines 11′ and 12′, a vacuum source 5, and a control unit 8.

Through the substrate supply line 11′, a substrate that is to be thickened and is made up of liquid and solid material, such as liquid manure from a stall or digestate from a biogas facility, can be supplied to a substrate inlet 11 of the device 1. Connected to the substrate inlet 11, to the left, there is a liquid separator 2, of which in FIG. 1 only an outer jacket 21 and a collecting funnel 23 situated on its lower side are visible. Inside the liquid separator 2, a separation of solid material and liquid is carried out by a filter pipe and a screw conveyor. The liquid flows through the collecting funnel 23 to a liquid outlet 12, forming the lowest point of the funnel, to which the liquid carry-off line 12′ is connected.

In the liquid carry-off line 12′, there is connected the vacuum source 5, here in the form of a rotary piston pump. During operation of the device 1 and of the rotary piston pump, the pump on the one hand produces a vacuum inside the device 1, in particular producing a difference in pressure between the outside and the inside of the filter pipe in the liquid separator 2, and on the other hand works to convey the liquid separated out from the substrate.

So that the desired vacuum forms inside the device 1, a throttle 7 is allocated to or connected before its substrate inlet 11. In the exemplary embodiment shown in FIG. 1, the throttle 7 is for example situated, simply as a screen, in the region of a connecting flange of the substrate inlet 11.

Alternatively to the screen 7, in the substrate supply line 11′ there can be connected a conveyor device 6, for example in the form of a second pump, indicated in FIG. 1 by dashed lines. In this case, the vacuum source 5 and the conveyor device 6 are each connected to the control unit 8, which regulates the power of the vacuum source 5 and of the conveyor device 6 and adjusts them to one another in such a way that the desired vacuum is set in the device 1 between the conveyor device 6 and the vacuum source 5, and is maintained during operation of the device 1. In order to determine the vacuum prevailing in the device 1, for example a vacuum sensor 80 attached on the jacket 21 can be used, that is likewise connected, in a manner not shown, to the control unit 8, and that supplies measurement signals to the control unit 8 for the vacuum prevailing inside the device 1.

In the device 1 according to FIG. 1, at the left a pressure duct 3 is connected to the liquid separator 2, in which duct the solid material separated from the liquid and retained by the filter pipe can be conveyed in and pressed together by the screw conveyor that extends into the pressure duct 3. The pressure duct 3 has its own jacket 31 that is connected tightly to the jacket 21 of the liquid separator 2. Inside the jacket 31 there is situated a sieve pipe that is not visible here and that surrounds the screw conveyor, through which liquid exiting from the pressed-together solid material can flow into the jacket 31 and to its liquid outlet 13.

The left end of the device 1 in FIG. 1 is formed by a discharge box 45 in which there is situated (concealed here) a solid material outlet 14 that can be opened and closed and through which, in the open state, solid material from the pressure duct 3 can be discharged.

At the end of the liquid separator 2 at the right in FIG. 1, and of the substrate inlet 11, there is situated a rotary drive 24, here made up of an electric motor and a gear mechanism, for driving the screw conveyor inside the liquid separator 2. The rotary drive 24 is also connected to a control unit 8 in order to make it possible to set and regulate the drive power and/or rotational speed of the screw conveyor as needed.

During operation of the device 1, in the pressure duct 3 there arises a solid material plug that seals the solid material outlet 14 in airtight and liquid-tight fashion, but that permits the discharge of solid material. The throttle 7 on the substrate inlet 11, or the conveyor device 6 in the substrate supply line 11′, provides a throttling of the inflow of the substrate. In this way, the vacuum source 5 connected in the liquid carry-off line 12′, in the form of the pump, produces the desired partial vacuum whose magnitude is monitored and regulated by the control unit 8.

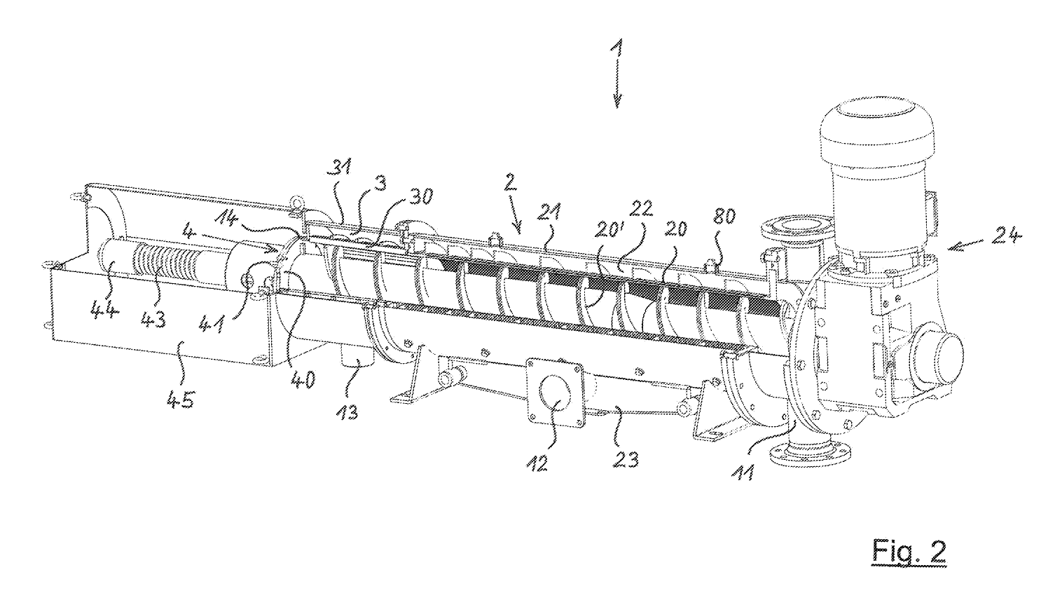

FIG. 2 of the drawing shows the device 1 from FIG. 1 in a partially cut-away view, now without the lines 11′ and 12′, without the vacuum source 5, and without the control unit 8.

At the far right in FIG. 2, the rotary drive 24 for a screw conveyor 20′ is flanged onto the liquid separator 2. Between the jacket 21 of the liquid separator 2 on the one hand and the rotary drive 24 on the other hand, the substrate inlet 11 is situated, to which the substrate supply line 11′ (not shown here) is to be connected.

At the left, a filter pipe 20 is connected to the substrate inlet 11, in which the pipe screw conveyor 20′ is situated so as to be capable of rotation. The jacket 21 surrounds the filter pipe 20 with a radial spacing therefrom. Between the outer circumference of the filter pipe 20 and the inner circumference of the jacket 21, a liquid space 22 is formed. This liquid space receives the liquid separated from the supplied substrate by the filter pipe 20, and supplies it to the collecting funnel 23 situated on the underside of the jacket 21. At the lowest part of the collecting funnel 23, the liquid outlet 12 is situated, to which the liquid discharge line 12′ (not shown here) can be connected.

In FIG. 2, the liquid separator 2 is followed at left by the pressure duct 3, into which the screw conveyor 20′ extends. The screw conveyor 20′ is here surrounded by a sieve pipe 30 through which liquid exiting from the solid material pressed together in the pressure duct 3 passes, and is then supplied to the associated liquid outlet 13 inside the jacket 31.

At its outer end, at left in FIG. 2, the pressure duct 3 is provided with a closure 4. Here, the closure 4 has the form of a closure plate 40 that can be displaced in the axial direction and can be rotated concentrically to the screw conveyor 20′. A spring 43 pre-loads the closure plate 40 with an axial force acting in the closing direction of the closure 4. One end of the spring 43 is supported on the closure plate 40, and its other end is supported on a spring support 44. Through axial displacement of the spring support 44, and fixing it in an appropriate position, the spring force acting on the closure plate 40 in the closing direction can be set as needed in the particular case.

In the closed position of the closure 4, the closure plate 40 lies in sealing fashion on the outer end of the pressure duct 3, sealing it. Here, in connection with the solid material plug that forms in the pressure duct 3 during operation of the device 1, an airtight and liquid-tight termination of the device 1 is achieved. At the same time, however, it is still possible for solid material to be discharged from the solid material plug. Here, solid material is discharged whenever the solid material plug in the pressure duct 3 exerts a force on the closure plate 40 that exceeds the force of the spring 43 acting in the closing direction.

Relative to the solid material plug in the pressure duct 3, the closure plate 40 executes a rotational movement, whereby, in connection with cutting and/or grating tools 41 provided on the closure plate 40, it loosens and disintegrates the solid material. In this disintegrated form, the discharged solid material then falls downward through the discharge box 45, and can be caught there in a collecting reservoir, or can be transported away by a conveyor device such as a conveyor belt. As soon as the force of the spring 43 again exceeds the force exerted on the closure plate 40 by the solid material plug, the closure plate 40 automatically moves back into its closed position.

During operation of device 1, a vacuum is produced by the vacuum source 5 in connection with the throttle 7 at the fluid outlet 12, as is shown in FIG. 1. This has the consequence that a difference in pressure arises between the interior of the filter pipe 20 and the liquid space 22, and a carpet-type coating of solid material supplied with the substrate is intentionally built up on the inner circumference of the filter pipe 20. The carpet-type coating of solid material then acts intentionally as an extremely fine filter, in which fine solid material portions are deposited, for example nutrients, such as phosphorus, that are supplied in the substrate but whose presence is not desired in the separated liquid.

The screw conveyor 20′ can be adjusted, preferably continuously, by means of its rotational drive 24 coupled to the control unit 8, so that, supported by a vacuum, a filter carpet made of solid material is always present in a desired thickness on the inner circumference of the filter pipe 20. The screw conveyor 20′ continually removes the coating, and conveys the saturated solid material in the direction toward the pressure duct 3 and toward the solid material outlet 14.

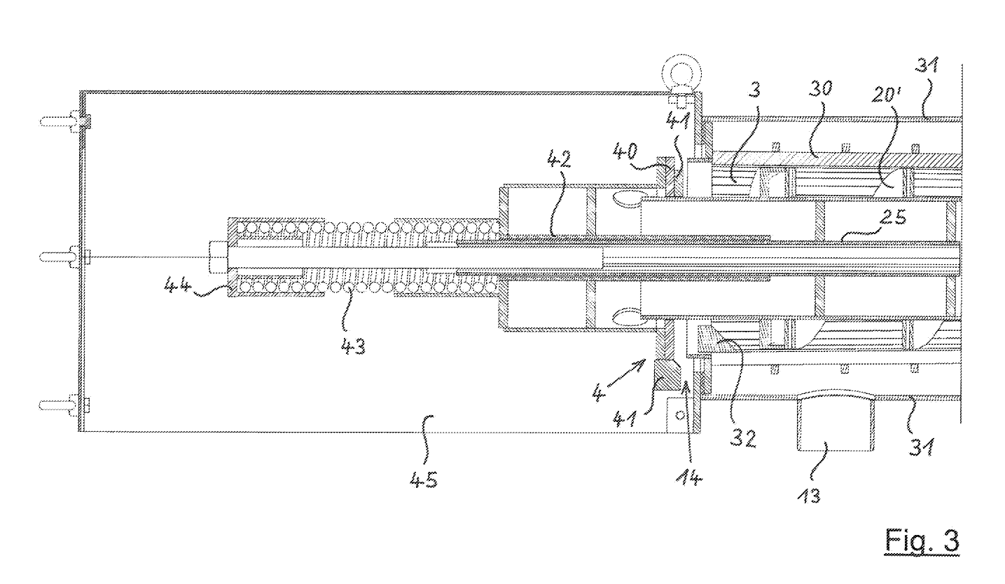

FIG. 3 of the drawing shows, in an enlarged view, the left end region in FIG. 2 of the device 1, with its solid material outlet 14, in longitudinal section.

At the right in FIG. 3, another part of the pressure duct 3 is visible having the sieve pipe 30, the jacket 31 surrounding this pipe, and the associated liquid outlet 13. It can also be seen there that the screw conveyor 20′ extends into the sieve pipe 30.

At the end of the pressure duct 3 at left in FIG. 3, the solid material outlet 14 is situated, to which the closure 4, in the form of the closure plate 40, is allocated. The closure plate 40 is here in its open position, in which it is situated at a distance in the axial direction from the end of the pressure duct 3. This axial spacing results when the solid material plug in the pressure duct 3 exerts a force on the side of the closure plate 40 oriented toward the right in FIG. 3 that exceeds the force of the spring 43 acting in the opposite direction.

The closure plate 40 can not only be displaced in the axial direction, but can also be rotated in its circumferential direction. For this purpose, in the exemplary embodiment shown the closure plate 40 is connected to a central, hollow shaft 42 in rotationally fixed fashion, the shaft being situated, in axially displaceable but rotationally fixed fashion, on an end region of a screw shaft 25 that extends past the end of the pressure duct 3 to the left.

In order to prevent solid material brought out through the solid material outlet 14 from coming out in undesirably large chunks, the closure plate 40 has the cutting and grating tools 41 on its side facing the pressure duct 3, as well as on its outer circumference. These tools 41 loosen and disintegrate the exiting solid material, which then, in friable form, falls through the downwardly open discharge box 45, and out of this box. So that the tools 41 can work effectively, the solid material plug in the pressure duct 3 can be prevented from rotating in the pressure duct 3 by suitable guide means 32.

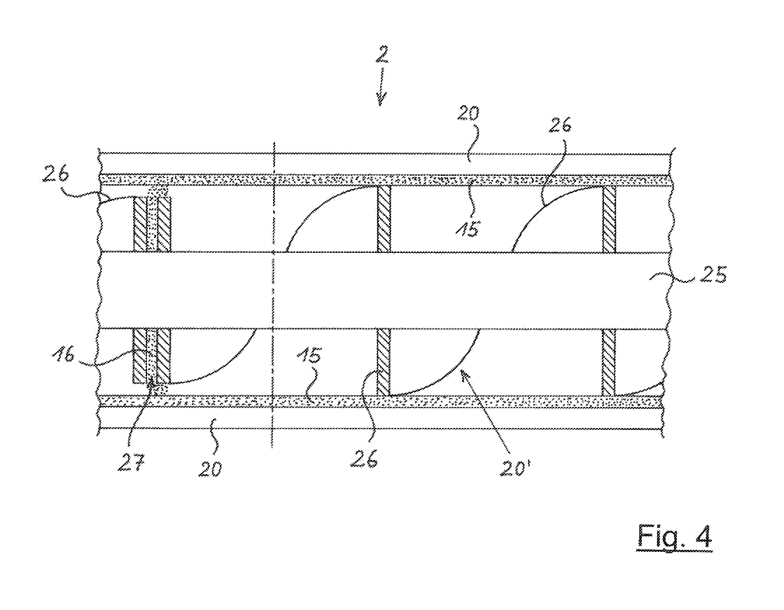

FIG. 4 shows a segment of the screw conveyor 20′, and the filter pipe 20 surrounding it, in longitudinal section. The central part of the screw conveyor 20′ forms its screw shaft 25 around which a helical vane 26 extends in helical fashion. The screw shaft 25 and the helical vane 26 are connected to one another in rotationally fixed fashion, and are realized for example as steel parts welded together.

FIG. 4 clearly shows that the screw conveyor 20′ has an outer diameter that is smaller than the inner diameter of the filter pipe 20. The size of this difference in the two diameters is chosen to be so large that during operation of the device a solid material coating 15 forms on the inner circumference of filter pipe 20 that has a layer thickness that corresponds to the difference in diameters.

Because the screw conveyor 20′ has an outer diameter that is smaller than the inner diameter of the filter pipe 20, the screw conveyor 20′ cannot reach the surface of the inner circumference of the filter pipe 20, and as a result, during operation of the device 1 the solid material coating 15 necessarily forms on the inner circumferential surface of the filter pipe 20, from the solid material contained in the substrate, due to the flow of liquid radially from the inside to the outside through the filter pipe 20. During operation of the device 1, this solid material coating 15 acts as an intentional filter coating that forms a filter element that, in particular, retains fine and extremely fine solid material particles from the substrate that would not be retained by the filter pipe 20 alone. Given, for example, a use of the device 1 in order to thicken liquid manure from stalls, or digestate from biogas facilities, a significant portion of the undesirable nutrients, in particular phosphorus or phosphates, as well as nitrates, that are present in the incident liquid phase are retained in the filter coating 15. The screw conveyor 20′ removes excess coating, but always leaves the desired layer coating thickness on the inner circumference of the filter pipe.

The helical vane 26 is usefully fashioned having a closed surface on its outer circumference, in order to produce and maintain the solid material coating 15 with a defined layer thickness. It is also possible to fashion the helical vane 26 having a groove 27 on its outer circumference that is radially outwardly open, in which solid material, in particular in the form of fibrous materials 16, collects and settles during operation of the device 1. These fibrous materials 16 protrude from the groove 27 past the outer circumference of the helical vane 26, forming a kind of brush that during rotation of the screw conveyor 20′ passes over the inner circumference of the solid material coating 15 without, however, extending up to the inner circumference of the filter pipe 20. In this way, a less aggressive removal of the excess solid material coating 15 can be achieved, but at the cost of lower dimensional precision of the layer thickness of the solid material coating 15. In order, in this case, to prevent excessive removal of the solid material coating 15 from the inner circumference of filter pipe 20, the dimensional difference between the outer diameter of the screw conveyor 20′ and the inner diameter of the filter pipe 20 is usefully selected to be larger, for example twice as large, than is the case given the use of the helical vane 26 having a closed surface on its outer circumference.

During operation of the device 1, the growth of the solid material coating 15 can be influenced by changing the rotational speed of the screw conveyor 20′, and in particular can be promoted by reducing the rotational speed. The lower the rotational speed of the screw, the longer is the dwell time of the solid material formed in particular by fibrous materials, and the thicker is the produced solid material coating. This solid material coating that is formed acts as an intentional filter mat. Trials and measurements have shown that a significant portion of the nutrients supplied in the substrate, in particular phosphorus, collects in this filter mat and is thus not carried away with the liquid phase.

The screw conveyor 20′ transports the removed, saturated solid material of the excess coating in the direction toward the solid material outlet 14, into the associated pressure duct 3. The liquid phase separated from the solid material then has only a significantly reduced remaining content of nutrients, and can be used for irrigation purposes, or can be introduced into a drainage ditch, without causing unacceptable nutrient loading. The solid material separated in the device, with the nutrients contained therein, provides—after additional drying if needed—a dunging material that can be transported and stored and that can be spread onto agricultural areas at times and places where there is a need for dunging.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE CHARACTERS

1 device
11 substrate inlet
11′ substrate supply line
12 liquid outlet at 21
12′ liquid carry-off line
13 liquid outlet at 31
14 solid material outlet
15 solid material coating
16 fibrous materials in 27
2 liquid separator
20 filter pipe
20′ screw conveyor in 2
21 jacket around 20
22 liquid space in 21
23 collecting funnel
24 rotational drive of 20
25 screw shaft
26 helical vane
27 groove in 26
3 pressure duct
30 sieve pipe
31 jacket around 30
32 guide means
4 closure
40 closure plate
41 cutting and/or grating tool
42 shaft of 40
43 spring on 40
44 spring support
45 discharge box
5 vacuum source (first pump)
6 conveyor device (second pump)
7 throttle
8 control unit
80 vacuum sensor(s)

1-26. (canceled)

27. A device for thickening liquid substrate containing solid material, comprising:
at least one filter pipe that is permeable to liquid and that retains solid material,
a screw conveyor arranged to rotate in the filter pipe,
a substrate inlet leading into the filter pipe,
a liquid outlet going out externally from the filter pipe, and
a solid material outlet,
wherein solid material from the introduced substrate is capable of being deposited on an inner surface of the filter pipe, and,
wherein using the screw conveyor, solid material for the formation of a solid material plug is capable of being pressed into a pressure duct situated between the filter pipe and the solid material outlet, and being capable of being discharged from the pressure duct through the solid material outlet,
the screw conveyor having an outer diameter that is smaller than an inner diameter of the filter pipe by an amount that permits a formation of a carpet-type solid material coating, forming a fine filter, on an inner circumference of the filter pipe.

28. The device as recited in claim 27, wherein the outer diameter of the screw conveyor is smaller than the inner diameter of the filter pipe by from 0.5 to 5 mm.

29. The device as recited in claim 27, wherein a vacuum source is connected or can be connected to the liquid outlet, by which vacuum source a difference in pressure, with the pressure decreasing from the inside to the outside, can be produced between an interior of the filter pipe and an exterior of the filter pipe.

30. The device as recited in claim 29, wherein a vacuum relative to the surrounding environment can be produced in the filter pipe by the vacuum source.

31. The device as recited in claim 30, wherein a throttle is allocated to or connected before the substrate inlet.

32. The device as recited in claim 27, wherein the filter pipe is surrounded radially externally at a distance by a tight jacket, and wherein a liquid space is formed between the filter pipe and the jacket, and wherein the jacket has the liquid outlet in its region that is its lowermost region during operation of the device.

33. The device as recited in claim 29, wherein the vacuum source is a liquid pump whose suction side is connected, or can be connected, to the liquid outlet.

34. The device as recited in claim 33, wherein a liquid carry-off line that carries off the liquid is connected to the liquid outlet, and wherein the liquid pump acting as the vacuum source is inserted in the liquid carry-off line.

35. The device as recited in claim 31, wherein the throttle is formed by a fixed or adjustable narrowing of the cross-section of the substrate inlet, or by a fixed or adjustable narrowing of the cross-section of a substrate supply line connected before the substrate inlet.

36. The device as recited in claim 31, wherein the throttle is formed by a conveyor device situated in the substrate inlet or in a substrate supply line connected before this inlet, whose power, relative to the power of the vacuum source, can be controlled in such a way that the difference in pressure between the interior of the filter pipe and the exterior of the filter pipe arises having a desired magnitude.

37. The device as recited in claim 27, wherein the screw conveyor has a screw shaft that is led out in sealing fashion from the filter pipe at the inlet-side end of the screw conveyor, and that is connected to a motoric rotary drive having a variable rotational speed.

38. The device as recited in claim 27, wherein the solid material outlet can be closed by a movable closure, and can be released for the discharge of solid material.

39. The device as recited in claim 38, wherein the closure on the solid material outlet is formed by a closure plate that is mounted so as to be capable of being moved axially between a closed position and an open position, and is pre-loaded by a force acting in the closing direction.

40. The device as recited in claim 39, wherein the closure can be set into rotational motion by mechanical coupling to the screw conveyor or by a separate rotary drive.

41. The device as recited in claim 40, wherein the closure has, on its side oriented toward the solid material outlet, at least one cutting and/or grating tool for detaching and disintegrating solid material discharged from the solid material plug through the solid material outlet.

42. The device as recited in claim 38, wherein the closure at the solid material outlet is formed by a rotary piston pump.

43. The device as recited in claim 27, wherein the pressure duct is fashioned in the interior of a pipe segment that forms a continuation of the filter pipe and is closed at its circumference, or is fashioned in the manner of a sieve at its circumference.

44. The device as recited in claim 43, wherein the pipe segment, if it is realized as a sieve pipe, is tightly surrounded by a separate, second jacket, and has a separate, second liquid outlet.

45. A method for thickening liquid substrate containing solid material, comprising the steps:
guiding the substrate in at least one filter pipe that is permeable to liquid and that retains solid material,
rotating a screw conveyor in the filter pipe,
depositing solid material from the introduced substrate on an inner surface of the filter pipe,
pressing solid material, by the screw conveyor, into a pressure duct situated between the filter pipe and a solid material outlet in order to form a solid material plug,
discharging the solid material plug from the pressure duct through the solid material outlet,
producing a carpet-type solid material coating on the inner circumference of the filter pipe that forms a hollow cylindrical fine filter,
the screw conveyor having an outer diameter that is smaller than an inner diameter of the filter pipe by an amount that permits the formation of the carpet-type solid material coating.

46. The method as recited in claim 45, wherein the carpet-type solid material coating is produced on the inner circumference of the filter pipe having a layer thickness of from 0.5 to 5 mm.

47. The method as recited in claim 45, including a step of producing a difference in pressure, with pressure decreasing from the inside to the outside, between an interior of the filter pipe and an exterior of the filter pipe by a vacuum source that is connected to, or can be connected to, the liquid outlet.

48. The method as recited in claim 47, including producing a vacuum relative to the surrounding environment in the filter pipe by the vacuum source.

49. The method as recited in claim 48, wherein the substrate flow is throttled in or before the substrate inlet.

50. The method as recited in claim 47, comprising the step of using a liquid pump acting as vacuum source to produce the difference in pressure, whose suction side is connected, or can be connected, to the liquid outlet.

51. The method as recited in claim 47, including the step of conveying the substrate through the substrate inlet into the filter pipe by the vacuum, relative to the surrounding environment, produced in the filter pipe by the vacuum source.

52. The method as recited in claim 47, wherein the substrate is supplied to the substrate inlet by a conveyor device connected before this inlet, and wherein the conveyor device and the vacuum source are calibrated to one another in such a way that during operation of the device the difference in pressure between the interior of the filter pipe and the exterior of the filter pipe is produced having a desired magnitude.
